(19) United States
(12) Patent Application Publication
(10) Pub. No.: US 2017/0241194 A1
(43) Pub. Date: Aug. 24, 2017

(54) Shutter Within a Shutter and Methods for Forming Same

(71) Applicant: Houston Shutters, LLC, Houston, TX (US)

(72) Inventors: Michael Blackburn, Houston, TX (US); Jennifer Baur, Houston, TX (US)

(21) Appl. No.: 15/048,540

(22) Filed: Feb. 19, 2016

(51) Int. Cl. E06B 7/09; E05D 15/52; E06B 3/50

(52) U.S. Cl. CPC E06B 7/09; E06B 3/5036; E05D 15/52; E06B 2007/026

(57) ABSTRACT

A shutter assembly includes a frame, at least one shutter panel coupled to the frame and configured to pivot about a first axis, and at least one louvered subpanel hinged to the shutter panel and configured to pivot about a second axis, wherein the first axis is not parallel to the second axis.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Field of the Disclosure

This disclosure relates generally to shutters, such as for covering window or door openings. More particularly, it relates to shutter panels and assemblies having frames and shutter panels retained therein.

Background Information

The design, fabrication, assembly, and installation of shutters (i.e. shutter panels or shutter assemblies) for window and door openings or casings can control light into a room, and add storm protection, privacy, or aesthetic beauty to homes and other buildings. Some shutters are functional, such as panels that pivotally mount to a window or door casing, allowing the panels to be selectively pivoted to cover a window or door opening or pivoted to the side of the opening. Other shutters are cosmetic, giving aesthetic appeal without allowing movement. Panels for functional or cosmetic shutters commonly include a series of louvers. For functional shutters, the louvers may be pivotable or may be fixed in place relative to a panel frame.

Design features that improve the appearance or performance of the shutters; that reduce manufacturing, assembly, and/or transportation costs; and/or that simplify the assembly of shutters are desirable to maintain an economic or another competitive advantage.

### BRIEF SUMMARY OF THE DISCLOSURE

These and other needs in the art are addressed herein. In one embodiment, a shutter assembly includes a frame and at least one shutter panel coupled to the frame and configured to pivot about a first axis, the shutter panel comprising a panel body. Further, the shutter assembly includes at least one louvered subpanel coupled to the shutter panel and configured to pivot about a second axis. In this embodiment, the first axis is not parallel to the second axis and, in certain embodiments, is generally perpendicular to the second axis.

In another embodiment, a shutter assembly includes a frame having a first and a second side member spaced-apart and extending lengthwise in a first direction, and having a first and a second cross member spaced apart from one another and extending between the side members in a second direction perpendicular to the first direction. In addition, the shutter assembly includes a shutter panel configured to swing between a closed position and an open position relative to the frame. The shutter panel includes a first and a second stile spaced-apart and extending lengthwise in a first direction, the first stile being pivotally attached to the frame's first side member or first cross-member, with the shutter panel also including a first and a second rail spaced apart and extending between the stiles in the second direction. Further, the shutter assembly includes louvered subpanel configured to swing between a closed position and an open position relative to the shutter panel. The subpanel includes a subpanel body pivotally attached to the first rail or the first stile and a first louver pivotally coupled within the subpanel body. In this embodiment, the shutter panel is configured to swing about a first axis extending in the first direction, and the subpanel is configured to swing about a second axis extending in the second direction.

In still another embodiment, a shutter assembly includes a frame having a first aperture. In addition, the shutter assembly includes a primary shutter panel hinged to the frame and configured to fit within the first aperture and to pivot about a first axis from an opened position to a closed position, the primary shutter panel comprising a second aperture. Further, the shutter assembly includes a subpanel hinged to the primary panel and configured to fit within the second aperture and to pivot along a second axis that is substantially perpendicular to the first axis.

In still another embodiment, a shutter assembly includes a shutter panel comprising a panel body having a first and a second aperture therethrough. The shutter assembly includes a first louver pivotally coupled within the first aperture, and includes a subpanel configured to open and close the second aperture. Further, the shutter assembly includes a first pivotal coupling coupled to the shutter panel and configured to permit the shutter panel to pivot along a first axis, and includes a second pivotal coupling that couples the subpanel to the shutter panel and permits the subpanel to pivot along a second axis that is substantially perpendicular to the first axis.

Thus, embodiments described herein include a combination of features and characteristics intended to address various shortcomings associated with certain prior devices, systems, and methods. The various features and characteristics described above, as well as others, will be readily apparent to those of ordinary skill in the art upon reading the following detailed description, and by referring to the accompanying drawings.

### BRIEF DESCRIPTION OF THE DRAWINGS

For a detailed description of the disclosed embodiments of this disclosure, reference will now be made to the accompanying drawings in which:

FIG. 1 is a perspective front view of a shutter assembly having a shutter subpanel pivotally coupled within a primary shutter panel that, in turn, is pivotally coupled within a frame in accordance with principles described herein;

FIG. 2 is a perspective rear view of a portion of the shutter assembly of FIG. 1;

FIG. 3 is a perspective front view of another shutter assembly having three primary shutter panels like the primary shutter panel of FIG. 1 in accordance with principles described herein;

FIG. 4 is a perspective front view of a third shutter assembly, having two shutter subpanels pivotally coupled within a primary shutter panel in accordance with principles described herein; and

FIG. 5 is perspective front view of a fourth shutter assembly having a single shutter subpanel pivotally coupled within a primary shutter panel in accordance with principles described herein.

### NOTATION AND NOMENCLATURE

The following description is exemplary of certain embodiments of the disclosure. One of ordinary skill in the art will understand that the following description has broad application, and the discussion of any embodiment is meant only to be exemplary of that embodiment, and is not intended to suggest in any way that the scope of the disclosure, including the claims, is limited to that embodiment.

The drawing figures are not necessarily to scale. Certain features and components disclosed herein may be shown exaggerated in scale or in somewhat schematic form, and some details of conventional elements may not be shown in the interest of clarity and conciseness. In some of the figures, in order to improve clarity and conciseness of the figure, one or more components or aspects of a component may be omitted or may not have reference numerals identifying the features or components. In addition, among the drawings, like or identical reference numerals may be used to identify common or similar elements.

The terms “including” and “comprising” are used herein including the claims, in an open-ended fashion, and thus should be interpreted to mean “including, but not limited to . . . ” Also, the term “couple” or “couples” is intended to mean either an indirect or direct connection. Thus, if a first component couples or is coupled to a second component, the connection between the components may be through a direct engagement of the two components, or through an indirect connection that is accomplished via other intermediate components, devices and/or connections. The recitation “based on” means “based at least in part on.” Therefore, if X is based on Y, then X may be based on Y and any number of other factors.

In addition, as used herein including the claims, the terms “axial” and “axially” generally mean along or parallel to a given axis (e.g., a central axis of a body or a port), while the terms “radial” and “radially” generally mean perpendicular to the axis. For instance, an axial distance refers to a distance measured along or parallel to a given axis, and a radial distance means a distance measured perpendicular to the axis. As understood in the art, the use of the terms “parallel,” “perpendicular,” “vertical,” and “horizontal” may refer to idealized or precise conditions as well as to conditions in which to members are substantially parallel, substantially perpendicular, substantially vertical, or substantially horizontal, respectively. Furthermore, any reference to a relative direction or relative position is made for purpose of clarity, with examples including “top,” “bottom,” “up,” “upward,” “down,” “lower,” “clockwise,” “left,” “leftward,” “right” “right-hand,” “down”, and “lower.” For example, a relative direction or a relative position of an object or feature may pertain to the orientation as shown in a figure or as described. If the object or feature were viewed from another orientation or were implemented in another orientation, it may be appropriate to describe the direction or position using an alternate term. As used herein, including the claims, the term hinge refers broadly to any pivotal coupling, which includes, as examples, a conventional hinge having two plates joined by a pin, as well as an arrangement wherein a solitary pin extends between two other members that are to pivot or swing relative to another one another.

### DETAILED DESCRIPTION OF THE DISCLOSED EXEMPLARY EMBODIMENTS

This disclosure presents various embodiments of a frame assembly and shutter panels, which may be formed into a shutter assembly, all of which are applicable to fenestration, i.e. window and door openings, frames, or casings. The embodiments include assemblies having a primary shutter panel with at least one shutter subpanel pivotally coupled to the primary shutter panel, the subpanel configured to swing between at least one closed position and at least one open position relative to that primary shutter panel. In various embodiments, the shutter assembly includes one or more primary shutter panel pivotally coupled to a frame assembly, configuring the shutter panel to swing between at least one closed position and at least one open position relative to the frame along with the subpanel. The configuration allows the panel to be selectively positioned within the window or door opening or to the side of the opening. The panel or subpanel may include one or more louvers.

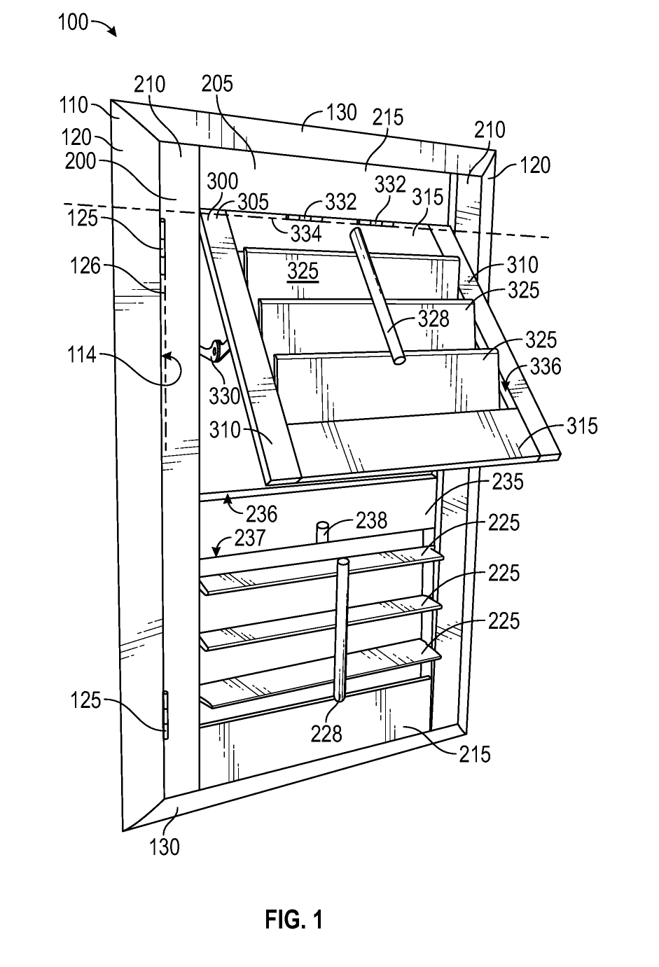

Referring to FIG. 1 an exemplary embodiment of a shutter assembly is shown in perspective view. Shutter assembly 100 includes a shutter frame 110 and a primary shutter panel 200 attached to frame 110 by a pivotal coupling, which includes two hinges 125 in this example. Frame 110 will also be called frame assembly. In FIG. 1, louvered primary shutter panel 200 is shown in a closed position within an aperture 114 of frame 110. This shutter panel 200 may also be rotated or pivoted to any number of open positions where it is pivotally displaced from frame 110 on hinges 125. Various embodiments include a plurality of primary panels 200 mounted in a frame 110, such as one, two, three, or four panels 200, as examples.

Frame 110 includes a pair of elongate, parallel side members 120 spaced-apart from one another, and includes a pair of elongate, parallel cross members 130 spaced-apart from one another and extending between the side members 120. Thus, side members 120 extend in a first direction, and cross members 130 extend in a second direction. In FIG. 1, the first direction is vertical, and second direction is horizontal; however, some other embodiments may orient one or both of these directions differently. As assembled, the side members 120 and cross members 130 form the generally rectangular aperture 114. In some embodiments, the side members 120 are not parallel, or the cross members 130 are not parallel and may form or include a trapezoidal shape or a curved shape, for example.

Hinges 125 are coupled between primary panel 200 and a side member 120 of frame 110. Hinges 125 are connected to frame 110 so as to have a common pivot axis 126 parallel to the side member 120, configuring panel 200 to pivot about axis 126. As examples, hinge 125 may be a mortise hinge installed in a mortise, i.e. a recess that is cut to match the size of the hinge, or may be a non-mortise hinge having two mounting plates displaced from one another along the pivot axis 126. In the orientation shown for frame 110 in FIG. 1, side members 120 and hinge axis 126 are vertical, and cross members 130 are horizontal.

Shutter panel 200 includes a panel body 205, a plurality of louvers 225 pivotally coupled to the panel body, and a lifting bar 228 coupled to the louvers by fasteners (not shown) that allow relative movement between louvers 225 and bar 228. Thus, panel 200 may also be called a louvered panel. Panel 200 further includes a subpanel 300 pivotally coupled to the panel body 205. Panel body 205 includes a pair of elongate, parallel, spaced-spaced apart stiles 210 and a pair of elongate, parallel, spaced-apart rails 215 that extend between and are perpendicular to the stiles 210. As such, panel body 205 may also be called a panel frame. The upper and lower rails 215 are located at opposite ends of the left and right stiles 210. The stile 210 on the left of FIG. 1 is pivotally attached to the frame's adjacent side member 120. In some embodiments, the stiles 210 are not parallel, or the rails 215 are not parallel and may form or include a trapezoidal shape or a curved shape, for example.

Louvers 225 are elongate and have two cylindrical axis pins or pin members (not shown) mutually aligned and extending from opposing ends of louver 225 and extending into the adjacent stiles 210. The two pins pivotally couple each louver 225 between the two stiles 210, parallel to rails 215. This embodiment includes three louvers 225 directly coupled to panel body 205 remaining adjacent and translationally fixed relative to stiles 210. Louvers 225 are coupled to panel 200 independently of subpanel 300. Other embodiments may have fewer or more louvers 225, such as one, two, ten, twenty-one, or any practical number of louvers.

Panel body 205 of louvered primary panel 200 further includes a divider rail 235 extending between the two stiles 210 located between the upper and lower rails 215. Divider rail 235 is spaced apart from upper rail 215, forming a generally rectangular upper aperture 236 in panel body 205. Divider rail 235 is also spaced apart from lower rail 215, forming a generally rectangular, lower aperture 237 in panel body 205. Divider rail 235 includes a mouse hole 238 to receive lifting bar 228. Louvers 225 are located between the divider rail 235 and the lower rail 215. Louvers 225 are received within lower aperture 237 and are configured to open and to close, variably, the lower aperture 237 in order to block or reduce the movement of light or air therethrough. In some embodiments similar to FIG. 1, the divider rail 235 is absent such that a single aperture 236 is formed in panel body 205, and both the subpanel 300 and the louvers 225 are received in the single aperture 236.

Continuing to reference FIG. 1, shutter subpanel 300, which is mounted to panel 200, includes a panel body 305, a plurality of louvers 325 pivotally coupled to panel body 305, and a lifting bar 328 coupled to the louvers by fasteners (not shown) that allow relative movement between louvers 325 and bar 328. An extendable-retractable support arm 330 supports subpanel 300, allowing it to be held at one or more a pivoted positions, rotationally displaced from primary panel 200. Panel body 305 includes a pair of parallel, spaced-spaced apart stiles 310 and a pair of parallel, spaced-apart rails 315 that extend between and are perpendicular to the stiles 310. As such, panel body 305 may also be called a panel frame. The upper and lower rails 315 are located at opposite ends of the left and right stiles 310. The upper rail 315 is pivotally coupled to the upper rail 215 of the outer panel body 205 by a pivotal coupling, which in this embodiment includes two hinges 332 sharing a common pivot axis 334 parallel to rails 215. Hinges 332 may be similar to hinges 125. The inner surfaces of stiles 310 rails 315 form a generally rectangular aperture 336 in panel body 305. Support arm 330 is coupled between stile 210 of panel body 205 and stile 310 of subpanel 300 and includes a pivot axis that is parallel to axis 334. Support arm 330 is shown as a type of hinge having two extending members joined by an intermediate pivot joint, allowing the two members to pivot relative to one another. As implemented in FIG. 1, the pivot joint and extending members of arm 330 move downward when they fold together. Optionally, support arm 330 may extend from primary panel 200 to subpanel 300 without an intermediate pivot joint. For example, the support arm may be a single rigid member or a piston-cylinder assembly. Some embodiments, a hinge 332 may be configured to maintain subpanel 300 at various angular locations with respect to panel 200 without the aid of support arm 330. For example, hinge 332 may be sufficiently stiff such that the weight of panel 300 cannot cause hinge 332 to rotate when panel 300 is in an open position.

Louvers 325 of shutter subpanel 300 are received within aperture 336 and are configured to open and to close, variably, aperture 336 in order to block or reduce the movement of light or air therethrough. Louvers 325 are elongate and have two cylindrical axis pins or pin members (not shown) mutually aligned and extending into the adjacent stiles 310. The two pins pivotally couple each louver 325 between the two stiles 310, parallel to rails 315. This embodiment includes three louvers 325 directly coupled to panel body 305 remaining adjacent and translationally fixed relative to stiles 310. Other embodiments may have fewer or more louvers 325. Because shutter subpanel 300 has pivotable louvers, it may also be called a louvered panel.

Subpanel 300 is configured to pivot about hinge axis 334 relative to the remainder of panel 200. In this embodiment, axis 334 is not parallel to axis 126, and is generally horizontal, and is perpendicular to axis 126, which is generally vertical. In FIG. 1, subpanel 300 is shown in an open position, pivotally displaced from panel body 205. Subpanel 300 may also be rotated or pivoted to a closed position where the full perimeter of subpanel 300 is positioned adjacent panel body 205. When closed, subpanel 300 rests within upper aperture 236. Optionally, when closed, panel 300 may rest adjacent but outside upper aperture 236. For example, the rear, outer surface of panel 300 may remain flush with the front, outer surface of panel 200 when panel 300 is closed against panel 200. Thus, subpanel 300, which is located between upper rail 215 and divider rail 235, is configured to open and to close the aperture 236 of primary panel 200. Subpanel 300 is configured to participate with primary panel 200 in opening and closing the shutter assembly 100. Subpanel 300 is configured to pivot about hinge axis 126 relative to frame 110 no matter the arcuate position of primary panel 200 relative to frame 110. That is, subpanel 300 is configured to move with primary panel 200 as primary panel 200 swings between a closed position and an open position, while subpanel 300 is in either the open or closed position relative to upper aperture 236 of primary panel 200.

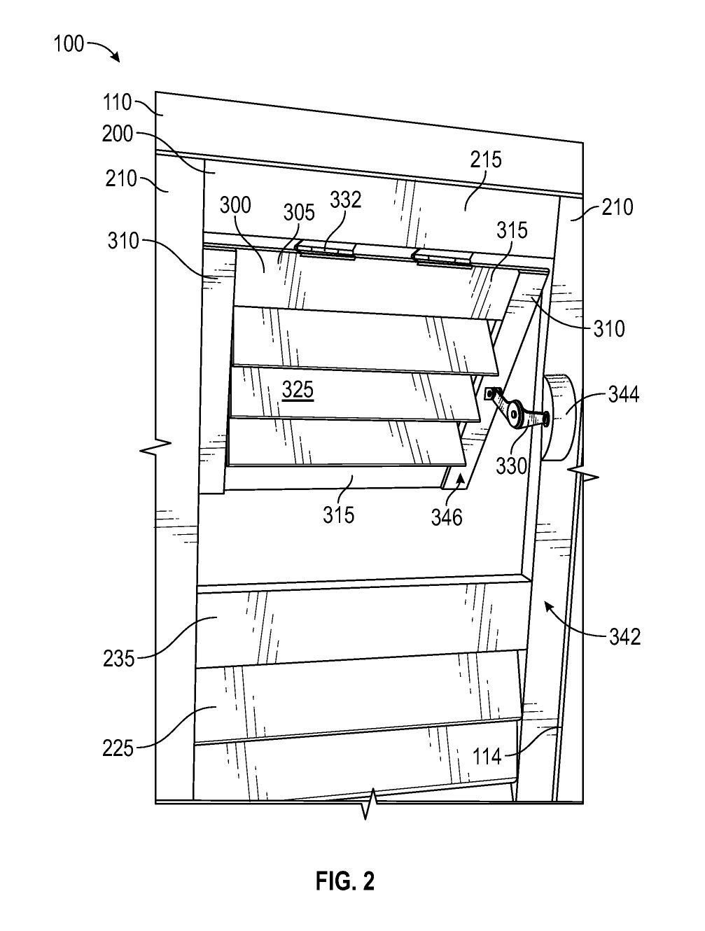

Referring now to FIG. 2, a rear view of shutter assembly 100 shows more details about the coupling between primary panel 200 and subpanel 300. Shutter primary panel 200 further comprises a rear shutter-face 342 and a mounting block 344 coupled to one of the stiles 210 along the rear shutter-face 342. Subpanel 300 further comprises a rear shutter-face 346, which may also be called a rear subpanel-face. The extendable-retractable support arm is coupled between the mounting block 344 and the rear subpanel-face 346 and may extend into stile 310

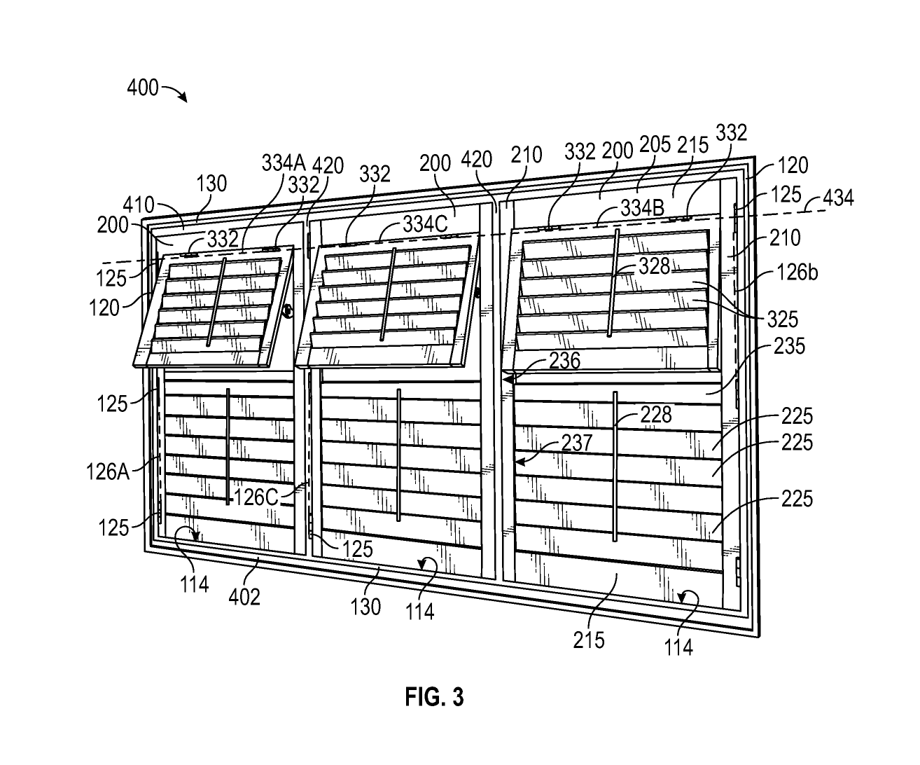

In FIG. 3, another exemplary embodiment of a shutter assembly is shown in perspective view. Shutter assembly 400 includes a shutter frame 410 and plurality of primary shutter panels 200, each attached to frame 410 by a pivotal coupling, which in FIG. 3 includes three hinges 125 aligned along a common vertical axis. As an exemplary installation, shutter assembly 400 is shown to be mounted to the interior side of a room window that includes its own trim or casing 402. Frame 410 is positioned within or adjacent the window casing 402.

Frame 410 includes many of the same features of frame 110 described above and may include one or more of the possible variations disclosed. For example, frame 410 includes a pair of elongate, parallel side members 120 spaced-apart from one another and includes a pair of elongate, parallel cross members 130 spaced-apart from one another and extending between the side members 120. Side members 120 extend in a first direction, and cross members 130 extend in a second direction. In addition, frame 410 includes a plurality of intermediate members 420 parallel the side members 120 and extending between the pair of cross members 130.

In the example of FIG. 3, frame 410 includes two intermediate members 420 equally spaced between side members 210, dividing the interior space of frame 410 into three generally rectangular apertures 414. Assembly 400, as a whole, includes three primary panels 200, each having three hinges 125 spaced along a stile 210 and coupled to a frame side member 120 or an intermediate member 420 and configured to be received within or adjacent one of the apertures 414. More specifically, a leftmost panel 200 and its three hinges 125 are attached to the leftmost side member 120 and are configured to pivot about a hinge axis 126A. A rightmost panel 200 and its three hinges 125 are attached to the rightmost side member 120 and are configured to pivot about a hinge axis 126B. A middle panel 200 and its three hinges 125 are attached to an intermediate member 420 and are configured to pivot about a hinge axis 126C. In the example shown, this coupling is implemented on the leftmost intermediate member 420. In this embodiment, axes 126A,B,C are parallel and vertical.

Shutter primary panels 200 of assembly 400 are louvered panels, having features similar to those previously described for the shutter primary panel 200 disclosed in relation to assembly 100 and may include any of the possible variations disclosed. For example, each panel 200 includes a panel body 205 formed from pair of parallel, spaced-spaced apart stiles 210 and a pair of parallel, spaced-apart rails 215 that extend between and are perpendicular to the stiles 210. Panel body 205 also includes a divider rail 235 positioned between the upper and lower rails 215 and extending between the two stiles 210, forming an upper aperture 236 and a lower aperture 237 in panel body 205. A shutter subpanel 300 is pivotally coupled to the panel body 205 within upper aperture 236, configured for the functionality previously described. A plurality of louvers 225 are pivotally coupled to the panel body 205 within lower aperture 237, configured for the functionality previously described. Another plurality of louvers 325 are pivotally coupled within panel body 305 of subpanel 300, configured for the functionality previously described. In this example, louvers 225, 325 may be pushed upward by a bar 228, 328, respectively, to achieve a closed position. FIG. 3 shows subpanels 300 partially open with respect to the various panel bodies 205.

Continuing to reference FIG. 3, the subpanel 300 associated with the leftmost panel 200 is coupled to the corresponding panel body 205 with at least one, and in this example two, hinges 332 and is configured to pivot about an axis 334A that is not parallel to axis 126A. In this embodiment, axis 334A is substantially horizontal and is perpendicular to axis 126A. In a similar configuration, the subpanel 300 associated with the rightmost panel 200 is coupled to the corresponding panel body 205 and is configured to pivot about a substantially horizontal axis 334B that is not parallel to axis 126B. Similarly, the subpanel 300 associated with the middle panel 200 is coupled to the corresponding panel body 205 and is configured to pivot about a substantially horizontal axis 334C that is not parallel to axis 126C. Thus, each shutter primary panel 200 fits within or adjacent one of the apertures 414 of frame 410 and is configured for the similar functionality as was described previously for shutter primary panel 200 within frame 110 of assembly 100. For example, each shutter primary panel 200 has at least one closed position and at least one open position with respect to frame 410.

As shown in FIG. 3 with all panels 300 in their closed positions, the subpanel axes 334A,B,C are coaxially aligned along a shared axis 434 that is fixed relative to frame 410 or relative to the window casing 402. As one or more primary panels 200 pivot to an open position with respect to frame 410, one or more of the axes 334A,B,C will move out-of-alignment or back into-alignment with respect to the shared axis 434, while another axis 334A,B,C may remain aligned with the shared axis 434.

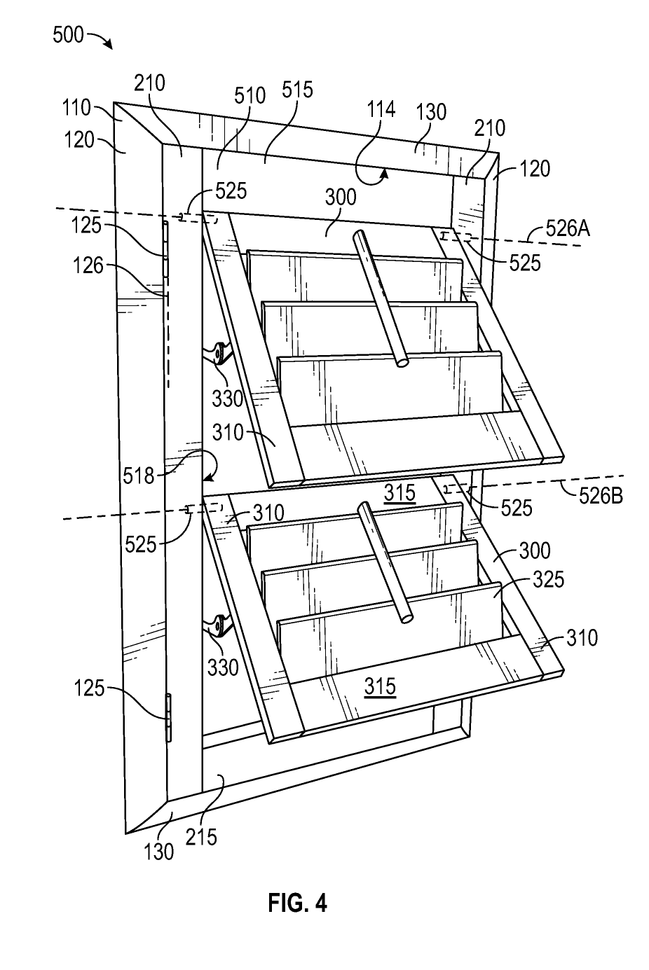

In FIG. 4, another exemplary embodiment of a shutter assembly is shown in perspective view. Shutter assembly 500 includes a primary shutter panel 510, pivotally coupled within a frame 110 by at least one pivotal coupling, and as shown, panel 510 is pivotally coupled by two hinges 125 aligned along a vertical axis 126.

Frame 110 of assembly 500 has the same features as the frame 110 described above and may include one or more of the possible variations disclosed. For example, frame 110 in FIG. 4 includes a pair of elongate, parallel side members 120 spaced-apart from one another and includes a pair of elongate, parallel cross members 130 spaced-apart from one another and extending between the side members 120. Side members 120 extend in a first direction, and cross members 130 extend in a second direction. Members 120, 130 form a generally rectangular aperture 114 configured to receive panel 510.

Panel 510 includes a panel body 515, which is formed as a frame, and a plurality of smaller, shutter subpanels 300 pivotally coupled to the panel body 515. Similar to panel body 205 (FIG. 1), the panel body 515 includes pair of parallel, spaced-spaced apart stiles 210 and a pair of parallel, spaced-apart rails 215 that extend between and are perpendicular to the stiles 210. Unlike panel body 205, panel body 515 lacks a divider rail, and no louvers are coupled directly within the panel body 515. The stiles 210 and rails 215 of body 515 form a single aperture 518. In other embodiments, panel body 515 will include at least one divider rail between the multiple shutter subpanels 300, forming multiple apertures in body 515.

The embodiment of FIG. 4 includes two shutter subpanels 300, one positioned directly above the other, both pivotally coupled within aperture 518. Each subpanel 300 has features similar to those previously disclosed in relation the subpanel 300 of assembly 100, and may include any of the possible variations disclosed. However, the mounting of subpanels 300 of assembly 500 is different from that described with reference to the embodiment of FIG. 1 and FIG. 3. Each subpanel 300 is pivotally coupled to body 515 by at least one pivotal coupling. More specifically, the upper rail 315 of each panel 300 is pivotally coupled to the stiles 210 of outer body 515 by two cylindrical pins 525 (shown by hidden lines in FIG. 4), one per side of each panel 300. The two pins 525 are aligned along an axis 526A extending through the top of the upper subpanel 300, and two pins 525 are aligned along an axis 526B extending through the top of the lower subpanel 300, adjacent the central region of aperture 518. Pins 525 extend within holes formed in stiles 210 of panel 510 and in stiles 310 of the respective subpanel 300. Pins 525 and axes 526A,B are disposed within the shutter panel's aperture 518 and extend beyond aperture 518. Axis 526A and axis 526B are mutually parallel, horizontal and are vertically spaced-apart, not aligned. Axes 526A,B are not parallel to vertical axis 126. Subpanel 300 is configured to pivot about axis 126 together with panel 510.

Shutter panel 510 within frame 110 of assembly 500 is configured for the similar functionality as was described previously for panel 200 within frame 110 of assembly 100. For example, each panel 510 has at least one closed position and at least one open position with respect to frame 110. Each subpanel 300 within panel 510 is configured for similar functionality as was described previously for subpanel 300 within panel 200. In FIG. 4, both of the two subpanels 300 are shown to be pivoted about axes 526A,B to an open position with respect to panel 510, guided or held by a hinge or an extendable-retractable support arm 330, which may be mounted as explained with respect to FIG. 1 and FIG. 2. Either shutter subpanel 300 may be pivoted to a closed position where the full perimeter of panel 300 is adjacent panel body 515 or disposed within aperture 518. When both shutter subpanels 300 are in their closed position, the bottom side of the upper subpanel 300 rests adjacent the top side of the lower subpanel 300. Seals or contoured shapes may be applied to one or more sides (e.g. top, bottom, left, or right) of the upper or the lower subpanel 300 or to panel body 515 in order to block light or reduce air flow more effectively when closed. Of course, this use of seals or a contoured shape may be applied to any of the embodiments of this disclosure.

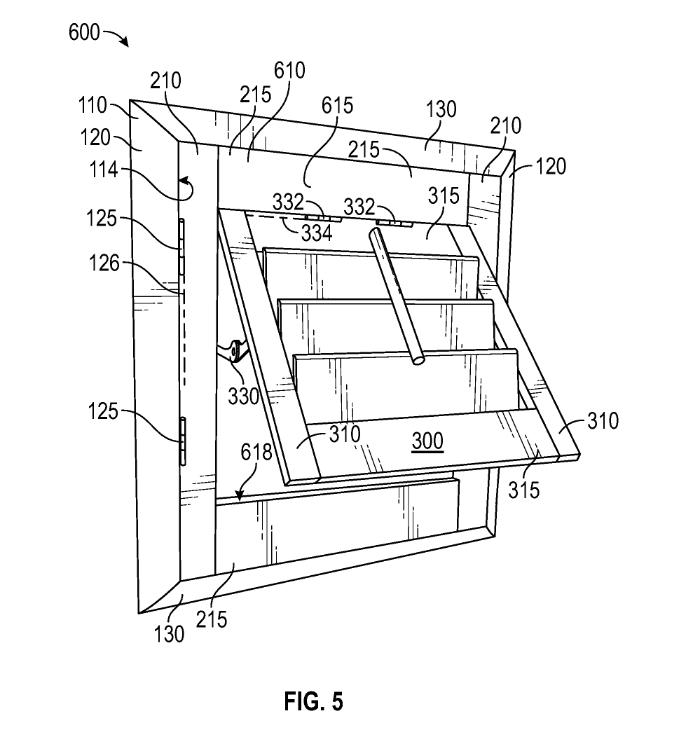

Referring now to FIG. 5, still another exemplary embodiment of a shutter assembly is shown in perspective view. Shutter assembly 600 includes a louvered primary shutter panel 610, attached to frame 110 by a pivotal coupling, which in FIG. 5 includes two hinges 125 aligned along a vertical axis 126.

Frame 110 of assembly 600 has the same features as the frame 110 described above and may include one or more of the possible variations disclosed. For example, frame 110 in FIG. 5 includes a pair of elongate, parallel side members 120 spaced-apart from one another and includes a pair of elongate, parallel cross members 130 spaced-apart from one another and extending between the side members 120. Side members 120 extend in a first direction, and cross members 130 extend in a second direction. Members 120, 130 form a generally rectangular aperture 114 configured to receive panel 610.

Shutter panel 610 includes a panel body 615, which is formed as a frame, and a smaller, shutter subpanel 300 pivotally coupled to the panel body 615. Similar to panel body 205 (FIG. 1) or panel body 515 (FIG. 4), the panel body 615 includes pair of parallel, spaced-spaced apart stiles 210 and a pair of parallel, spaced-apart rails 215 that extend between and are perpendicular to the stiles 210. Similar to panel body 515, panel body 615 is constructed without a divider rail 235, and no louvers are coupled directly within the panel body 615. The stiles 210 and rails 215 of frame 615 form a single aperture 618.

The embodiment of FIG. 5 a single, louvered shutter subpanel 300 is pivotally coupled within aperture 618, configuring it as a subpanel with respect to outer panel 610. Subpanel 300 has features similar to those previously disclosed in relation the subpanel 300 of assembly 100 and assembly 500, and may include any of the possible variations disclosed. For example, an upper rail 315 is pivotally coupled to the upper rail 215 of the outer frame 200 by a pivotal coupling, which in includes two hinges 332 sharing a common pivot axis 334 parallel to rails 215. In this embodiment, axis 334 is not parallel to axis 126, but is instead horizontal and perpendicular to axis 126, which is vertical.

Shutter primary panel 610 within frame 110 of assembly 600 is configured for the similar functionality as was described previously for shutter primary panel 200 within frame 110 of assembly 100. For example, shutter primary panel 610 has at least one closed position and at least one open position with respect to frame 110. Subpanel 300 within primary panel 610 is configured for the similar functionality as was described previously for subpanel 300 within primary panel 200. Sub panel 300 is configured to pivot about axis 126 together with panel 510. In FIG. 5, subpanel 300 is shown to be pivoted about axes 334 to an open position with respect to primary panel 610, guided or held by a hinge or an extendable-retractable support arm 330, which may be mounted as explained with respect to FIG. 1 and FIG. 2. Shutter subpanel 300 may be pivoted to a closed position where its full perimeter is adjacent panel body 615 or disposed within aperture 618.

Various exemplary embodiments consistent with the present disclosure have been presented. Multiple additional variations and uses are possible in accordance with principles described herein. Non-limiting examples are given here:

In some embodiments, a shutter assembly that has multiple primary shutter panels, as does assembly 400 of FIG. 3 for example, includes a panel 510 of FIG. 4 or a panel 610 of FIG. 5. Some of these embodiments include multiple panels 510 or panels 610 within the same frame, and other embodiments, include multiple types of primary shutter panels within a frame; the multiple types may include a combination of panels 200, 510, 610 or another primary shutter panel having a subpanel coupled to it in accordance with the teachings herein. Some shutter assembly embodiments may include a primary shutter panel 200, 510, 610 alongside a conventional shutter panel that has no subpanel pivotally coupled to it.

In various embodiments based on FIG. 1 or FIG. 3, etc., a subpanel 300 is disposed at a position toward the bottom of a primary panel, for example disposed adjacent or within aperture 237, and louvers 225 are disposed above the subpanel, for example disposed adjacent or within aperture 236.

In various embodiments, any primary panel may be mounted to a frame by the side hinges 125 of FIG. 1 or by pins like pins 525 of FIG. 4—although the pins for the primary panel may extend vertically rather than horizontally—or may be mounted by an another known pivotal coupling. In various embodiments, any subpanel may be mounted to a primary panel by the top hinges 332 of FIG. 1 or the side-pins 525 by of FIG. 4, an another known pivotal coupling.

While exemplary embodiments have been shown and described, modifications thereof can be made by one of ordinary skill in the art without departing from the scope or teachings herein. The embodiments described herein are exemplary only and are not limiting. Many variations and modifications of the apparatuses and processes described herein are possible and are within the scope of the disclosure. Accordingly, the scope of protection is not limited to the embodiments described herein, but is only limited by the claims that follow, the scope of which shall include all equivalents of the subject matter of the claims. The inclusion of any particular method step or action does not necessarily mean that the particular step or action is necessary to the method. If feasible, the steps of a method may be performed in any order, and in some instances two or more of the method steps may be performed in parallel, rather than serially.

What is claimed is:

1. A shutter assembly comprising:
a frame;
at least one shutter panel coupled to the frame and configured to pivot about a first axis, the shutter panel comprising a panel body; and
at least one louvered subpanel coupled to the shutter panel and configured to pivot about a second axis;
wherein the first axis is not parallel to the second axis.

2. The shutter assembly of claim 1 wherein the first axis is substantially vertical and the second axis is substantially horizontal.

3. The shutter assembly of claim 1 wherein the frame comprises: a pair of elongate side members; and a pair of generally parallel, elongate cross members extending between the side members; and
wherein the first side member of the pair of side members couples to the at least one shutter panel; and
wherein the at least one shutter panel is a louvered shutter panel comprising at least a first louver pivotally coupled within the panel body and spaced apart from the subpanel.

4. The shutter assembly of claim 1 wherein the at least one subpanel is a louvered subpanel comprising:
a subpanel body; and
at least a second louver pivotally coupled within the subpanel body.

5. The shutter assembly of claim 1 further comprising an extendable-retractable support arm coupled between the shutter panel and the subpanel.

6. The shutter assembly of claim 5 wherein the shutter panel further comprises a rear shutter-face, and the subpanel further comprises a rear subpanel-face;
wherein the shutter assembly further comprises a mounting block coupled along the rear shutter-face; and
wherein the support arm extends between the mounting block and the rear subpanel-face.

7. The shutter assembly of claim 1 wherein the shutter panel further comprises:
a divider rail disposed within the panel body and forming a first and a second aperture in the panel body; and
a first louver pivotally coupled within the first aperture;
wherein the subpanel is configured to open and close the second aperture.

8. The shutter assembly of claim 1 further comprising:
a first shutter panel configured to pivot about the first axis and a second shutter panel configured to pivot about a third axis that is spaced apart from and substantially parallel to the first axis; and
a first louvered subpanel coupled to the first shutter panel configured to pivot about the second axis, and a second louvered subpanel coupled to the second shutter panel and configured to pivot about a fourth axis; and
wherein the fourth axis is not parallel to the third axis.

9. The shutter assembly of claim 8 wherein the first shutter panel is configured to pivot between a plurality of first panel positions relative to the frame, carrying the corresponding louvered subpanel to each position;
wherein the second shutter panel is configured to pivot between a plurality of second panel positions relative to the frame carrying the corresponding louvered subpanel to each position; and
wherein for at least one position of the plurality of first panel positions and at least one position of the plurality of second panel positions, the fourth axis is not parallel to the second axis.

10. The shutter assembly of claim 9 wherein for at least one position of the plurality of first panel positions and at least one position of the plurality of second panel positions, the fourth axis is parallel to the second axis.

11. A shutter assembly comprising:
a frame comprising:
a first and a second side member spaced-apart and extending lengthwise in a first direction; and
a first and a second cross member spaced apart from one another and extending between the side members in a second direction perpendicular to the first direction;
a shutter panel configured to swing between a closed position and an open position relative to the frame and comprising:
a first and a second stile spaced-apart and extending lengthwise in a first direction, the first stile being pivotally attached to the frame's first side member or first cross-member; and
a first and a second rail spaced apart and extending between the stiles in the second direction; and
a louvered subpanel configured to swing between a closed position and an open position relative to the shutter panel and comprising:
a subpanel body pivotally attached to the first rail or the first stile; and
a first louver pivotally coupled within the subpanel body;
wherein the shutter panel is configured to swing about a first axis extending in the first direction, and the subpanel is configured to swing about a second axis extending in the second direction.

12. The shutter assembly of 11 wherein the shutter panel further comprises a rear shutter-face, and the subpanel further comprises a rear subpanel-face; and
wherein the shutter assembly further comprises
a mounting block coupled along the rear shutter-face; and
an extendable-retractable support arm extending between the mounting block and the rear subpanel-face.

13. The shutter assembly of 11 wherein the shutter panel further comprises:
a divider rail disposed between the louvered subpanel and the second rail and extending between the stiles; and
a second louver pivotally coupled to the stiles and disposed at a position between the divider rail and the second rail.

14. The shutter assembly of 11 wherein the louvered subpanel is a first louvered subpanel disposed adjacent the first rail; and
wherein the shutter assembly further comprises a second louvered subpanel disposed between the first louvered subpanel and the second rail, the second subpanel configured to swing between a closed position and an open position relative to the shutter panel.

15. The shutter assembly of 14 wherein the shutter panel further comprises a divider rail disposed between the first and a second rail and extending between the stiles;
wherein the first louvered subpanel is disposed at a position between the first rail and the divider rail; and
wherein the second louvered subpanel is disposed at a position between the divider rail and the second rail.

16. A shutter assembly, comprising:
a frame having a first aperture;
a primary shutter panel hinged to the frame and configured to fit within the first aperture and to pivot about a first axis from an opened position to a closed position, the primary shutter panel comprising a second aperture;
a subpanel hinged to the primary panel and configured to fit within the second aperture and to pivot along a second axis that is substantially perpendicular to the first axis.

17. The shutter assembly of claim 16 further comprising:
a first plurality of louvers pivotally coupled to the primary shutter, coupled independently of the subpanel; and
a second plurality of louvers pivotally coupled to the subpanel, configured to move with the subpanel.

18. The shutter assembly of claim 16 wherein the top of the subpanel is hinged to the primary panel; and wherein the second axis is horizontal.

19. The shutter assembly of 16 wherein the subpanel is a first subpanel; and
wherein the shutter assembly further comprises a second subpanel hinged to the primary panel and configured to pivot along a third axis that is substantially perpendicular to the first axis.

20. The shutter assembly of claim 16 wherein the primary shutter panel is a first primary shutter panel, and the subpanel is a first subpanel;
wherein the shutter assembly further comprises:
a second primary shutter panel hinged to the frame and configured to fit within the first aperture and to pivot about a third axis from an opened position to a closed position, the second primary shutter panel comprising a third aperture;
a second subpanel hinged to the second primary panel and configured to fit within the third aperture and to pivot along a fourth axis that is substantially perpendicular to the third axis.

21. A shutter assembly comprising:
a shutter panel comprising a panel body having a first and a second aperture therethrough;
a first louver pivotally coupled within the first aperture;
a subpanel configured to open and close the second aperture;
a first pivotal coupling coupled to the shutter panel and configured to permit the shutter panel to pivot along a first axis; and
a second pivotal coupling that couples the subpanel to the shutter panel and permits the subpanel to pivot along a second axis that is substantially perpendicular to the first axis.

22. The shutter assembly of claim 21 wherein the second pivotal coupling comprises a pin member extending into the second aperture.

23. The shutter assembly of claim 21 further comprising an extendable-retractable support arm coupled between the shutter panel and the subpanel, the support arm configured to hold the subpanel in either a closed position or in an open position relative to the shutter panel; and
wherein the subpanel comprises:
a subpanel body; and
a plurality of louvers pivotally coupled within the subpanel body.

24. The shutter assembly of claim 21 further comprising a frame;
wherein the first pivotal coupling is coupled between the shutter panel and the frame, and
wherein the shutter panel is configured to swing about the first axis between a closed position and an open position relative to the frame.
